(19) United States
(12) Patent Application Publication
(10) Pub. No.: US 2024/0113317 A1
(43) Pub. Date: Apr. 4, 2024

(54) FUEL CELL CHEMICAL FILTER MONITORING SYSTEM AND METHODS

(71) Applicant: Donaldson Company, Inc., Bloomington, MN (US)

(72) Inventors: Qinghui Yuan, Edina, MN (US); Poonam Sehrawat, New Delhi (IN); Gerald E. Weineck, St. Paul, MN (US)

(21) Appl. No.: 18/373,061

(22) Filed: Sep. 26, 2023

Related U.S. Application Data
(60) Provisional application No. 63/411,364, filed on Sep. 29, 2022.

(51) Int. Cl. H01M 8/0662; B01D 53/04; H01M 8/04089; H01M 8/0444

(52) U.S. Cl. CPC H01M 8/0687; B01D 53/0407; B01D 53/0454; H01M 8/04089; H01M 8/0444; B01D 2257/302; B01D 2257/304; B01D 2257/404; B01D 2257/406; B01D 2257/708; H01M 2250/20

(57) ABSTRACT

Embodiments herein relate to monitoring systems for chemical filters used with fuel cell systems. In an embodiment, a fuel cell chemical filter monitoring system is included having a processing unit and a sensor package. The sensor package can include one or more sensors. The sensor package can be configured to interface with an air flow channel of a fuel cell system upstream of a chemical filter and detect an amount of a chemical compound in the air flow channel. The sensor package can be operatively connected to the processing unit. The processing unit can be configured to track total exposure of the chemical filter to the chemical compound. The processing unit can be configured to estimate a remaining life of the chemical filter based on the tracked total exposure of the chemical filter and data regarding the total capacity of the chemical filter. Other embodiments are also included herein.

This application claims the benefit of U.S. Provisional Application No. 63/411,364, filed Sep. 29, 2022, the content of which is herein incorporated by reference in its entirety.

### FIELD

Embodiments herein relate to monitoring systems for chemical filters used with fuel cell systems.

### BACKGROUND

Fuel cells are electricity producing devices that consume hydrogen in a chemical reaction with oxygen producing water as a waste byproduct. Fuel cells have two electrodes, the anode and cathode. Fuel cells can be of various designs including alkaline fuel cells, polymer electrolyte membrane fuel cells, phosphoric acid fuel cells, molten carbonate fuel cells, and solid oxide fuel cells. Generally, fuel cells use catalysts including those formed with platinum, nickel, cobalt, iron, manganese, as well as other materials.

Many fuel cells are susceptible to damage from certain chemical species. For example, the catalysts used in various fuel cells are susceptible to catalyst poisoning from certain chemical species. As a result, it is desirable to filter out certain chemical species such as SO₂, H2S, NO₂, NH₃, and various volatile organic compounds (VOCs). However, most chemical filter have a finite capacity and when that capacity is exceeded then potentially damaging chemical species can enter the fuel cell.

### SUMMARY

Embodiments herein relate to monitoring systems for chemical filters used with fuel cell systems. In a first aspect, a fuel cell chemical filter monitoring system can be included having a processing unit and a sensor package. The sensor package can include one or more sensors. The sensor package can be configured to interface with an air flow channel of a fuel cell system upstream of a chemical filter and detect an amount of a chemical compound in the air flow channel. The sensor package can be operatively connected to the processing unit. The processing unit can be configured to track total exposure of the chemical filter to the chemical compound. The processing unit can be configured to estimate a remaining life of the chemical filter based on the tracked total exposure of the chemical filter and data regarding the total capacity of the chemical filter.

In a second aspect, in addition to one or more of the preceding or following aspects, or in the alternative to some aspects, the chemical compound can include at least one selected from the group consisting of an acid species, a base species, and a volatile organic compound.

In a third aspect, in addition to one or more of the preceding or following aspects, or in the alternative to some aspects, the chemical compound can include at least one selected from the group consisting of SO₂, H₂S, NO₂, NH₃, and a volatile organic compound.

In a fourth aspect, in addition to one or more of the preceding or following aspects, or in the alternative to some aspects, the sensors can include at least one selected from the group consisting of an acid sensor, a base sensor, and a volatile organic compound (VOC) sensor.

In a fifth aspect, in addition to one or more of the preceding or following aspects, or in the alternative to some aspects, the sensors can include at least one selected from the group consisting of an SO₂ sensor, an H₂S sensor, an NO₂ sensor, an NH₃ sensor, and a volatile organic compound (VOC) sensor.

In a sixth aspect, in addition to one or more of the preceding or following aspects, or in the alternative to some aspects, the fuel cell chemical filter monitoring system receives data regarding the total capacity from a remote system.

In a seventh aspect, in addition to one or more of the preceding or following aspects, or in the alternative to some aspects, the fuel cell chemical filter monitoring system receives data regarding the total capacity from the chemical filter itself.

In an eighth aspect, in addition to one or more of the preceding or following aspects, or in the alternative to some aspects, the fuel cell chemical filter monitoring system can be configured to send data regarding at least one of tracked total exposure and estimated remaining filter life.

In a ninth aspect, in addition to one or more of the preceding or following aspects, or in the alternative to some aspects, the data can be sent to a vehicle control system.

In a tenth aspect, in addition to one or more of the preceding or following aspects, or in the alternative to some aspects, the data can be sent to a vehicle CANbus system.

In an eleventh aspect, in addition to one or more of the preceding or following aspects, or in the alternative to some aspects, the data can be sent to a remote monitoring system.

In a twelfth aspect, in addition to one or more of the preceding or following aspects, or in the alternative to some aspects, the sensor package can further include at least one selected from the group consisting of a temperature sensor, a relative humidity sensor, and a pressure sensor.

In a thirteenth aspect, in addition to one or more of the preceding or following aspects, or in the alternative to some aspects, the sensor package can further include a flow sensor.

In a fourteenth aspect, in addition to one or more of the preceding or following aspects, or in the alternative to some aspects, further can include a geolocation circuit.

In a fifteenth aspect, in addition to one or more of the preceding or following aspects, or in the alternative to some aspects, the fuel cell chemical filter monitoring system can be configured to receive data regarding environmental levels of the chemical compound from a remote system using geolocation data from the geolocation circuit.

In a sixteenth aspect, in addition to one or more of the preceding or following aspects, or in the alternative to some aspects, the fuel cell chemical filter monitoring system can be configured to receive data regarding environmental levels of the chemical compound from a remote system.

In a seventeenth aspect, in addition to one or more of the preceding or following aspects, or in the alternative to some aspects, the fuel cell chemical filter monitoring system can be configured to use the received data to calibrate the one or more sensors.

In an eighteenth aspect, in addition to one or more of the preceding or following aspects, or in the alternative to some aspects, the fuel cell chemical filter monitoring system can be configured to use the received data to modulate estimate calculations regarding remaining life of the chemical filter.

In a nineteenth aspect, in addition to one or more of the preceding or following aspects, or in the alternative to some aspects, the processing unit can be configured to receive an input regarding a filter change event.

In a twentieth aspect, in addition to one or more of the preceding or following aspects, or in the alternative to some aspects, the input can be a user input.

In a twenty-first aspect, in addition to one or more of the preceding or following aspects, or in the alternative to some aspects, the input can be received from another sensor or system.

In a twenty-second aspect, in addition to one or more of the preceding or following aspects, or in the alternative to some aspects, the processing unit can be configured to receive data from a vehicular data system.

In a twenty-third aspect, in addition to one or more of the preceding or following aspects, or in the alternative to some aspects, the processing unit can be configured to receive data regarding power output from the fuel cell.

In a twenty-fourth aspect, in addition to one or more of the preceding or following aspects, or in the alternative to some aspects, the processing unit can be configured to use the data regarding power output to modulate estimate calculations regarding remaining life of the chemical filter.

In a twenty-fifth aspect, in addition to one or more of the preceding or following aspects, or in the alternative to some aspects, the vehicular data system can include a CANbus system.

In a twenty-sixth aspect, in addition to one or more of the preceding or following aspects, or in the alternative to some aspects, the sensor package further can include parallel flow paths, wherein individual sensors can be disposed within individual parallel flow paths.

In a twenty-seventh aspect, in addition to one or more of the preceding or following aspects, or in the alternative to some aspects, the fuel cell chemical filter monitoring system can be configured to issue an alert when the remaining life the chemical filter crosses a threshold value.

In a twenty-eighth aspect, in addition to one or more of the preceding or following aspects, or in the alternative to some aspects, the fuel cell chemical filter monitoring system can be configured to issue alerts according to a tiered severity scheme when the remaining life the chemical filter crosses one or more threshold values.

In a twenty-ninth aspect, in addition to one or more of the preceding or following aspects, or in the alternative to some aspects, the processing unit can be configured to estimate a remaining life of the chemical filter based on the tracked total exposure of the chemical filter and the data regarding the total capacity of the chemical filter using a linear equation, a non-linear equation, a machine-learning derived algorithm, a neural network, a simulation, or a digital twin.

In a thirtieth aspect, a method of monitoring a fuel cell chemical filter can be included. The method can include interfacing with an air flow channel of a fuel cell system upstream of a chemical filter, detecting an amount of a chemical compound in the air flow channel, tracking total exposure of the chemical filter to the chemical compound, and estimating a remaining life of the chemical filter based on the tracked total exposure of the chemical filter and data regarding the total capacity of the chemical filter.

In a thirty-first aspect, in addition to one or more of the preceding or following aspects, or in the alternative to some aspects, the method can further include sending data regarding at least one of tracked total exposure and estimated remaining filter life.

In a thirty-second aspect, in addition to one or more of the preceding or following aspects, or in the alternative to some aspects, the method can further include receiving data regarding environmental levels of the chemical compound from a remote system.

In a thirty-third aspect, in addition to one or more of the preceding or following aspects, or in the alternative to some aspects, the method can further include sending geolocation data to the remote system.

In a thirty-fourth aspect, in addition to one or more of the preceding or following aspects, or in the alternative to some aspects, receiving data regarding environmental levels of the chemical compound from a remote system can include using the received data to modulate estimate calculations regarding remaining life of the chemical filter.

In a thirty-fifth aspect, in addition to one or more of the preceding or following aspects, or in the alternative to some aspects, receiving data regarding environmental levels of the chemical compound from a remote system can include using the received data to calibrate one or more sensors.

In a thirty-sixth aspect, in addition to one or more of the preceding or following aspects, or in the alternative to some aspects, the method can further include receiving an input regarding a filter change event.

In a thirty-seventh aspect, in addition to one or more of the preceding or following aspects, or in the alternative to some aspects, the method can further include receiving data from a vehicular data system.

In a thirty-eighth aspect, in addition to one or more of the preceding or following aspects, or in the alternative to some aspects, the method can further include receiving data regarding power output from the fuel cell.

In a thirty-ninth aspect, in addition to one or more of the preceding or following aspects, or in the alternative to some aspects, wherein receiving the data regarding power output from the fuel cell includes using the data regarding power output to modulate estimate calculations regarding remaining life of the chemical filter.

In a fortieth aspect, in addition to one or more of the preceding or following aspects, or in the alternative to some aspects, the method can further include issuing an alert when the remaining life the chemical filter crosses a threshold value.

In a forty-first aspect, in addition to one or more of the preceding or following aspects, or in the alternative to some aspects, the method can further include issuing alerts according to a tiered severity scheme when the remaining life the chemical filter crosses one or more threshold values.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of fuel cell chemical filter monitoring system in accordance with various embodiments herein.

FIG. 2 is a schematic view of components of a fuel cell chemical filter monitoring system in accordance with various embodiments herein.

FIG. 3 is a schematic view of components of a fuel cell chemical filter monitoring system in accordance with various embodiments herein.

FIG. 4 is a schematic view of components of a fuel cell chemical filter monitoring system in accordance with various embodiments herein.

FIG. 5 is a schematic view of a portion of a sensor package in accordance with various embodiments herein.

FIG. 6 is a schematic view of a portion of a sensor package in accordance with various embodiments herein.

FIG. 7 is a schematic view of a portion of a sensor package in accordance with various embodiments herein.

FIG. 8 is a flowchart of operations in accordance with various embodiments herein.

FIG. 9 is a flowchart of operations in accordance with various embodiments herein.

FIG. 10 is a flowchart of operations in accordance with various embodiments herein.

FIG. 11 is a block diagram view of components of a processing unit in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Many fuel cells are susceptible to damage from certain chemical species. For example, the catalysts used in various fuel cells are susceptible to catalyst poisoning from certain chemical species. Therefore, it is desirable to filter out certain chemical species such as SO₂, H2S, NO₂, NH₃, and various volatile organic compounds (VOCs).

Various chemical filters have been developed for use with fuel cells to remove chemical species such as SO₂, H2S, NO₂, NH₃, and various volatile organic compounds (VOCs). Generally, function in a manner such that they have a fixed total capacity to remove such chemical compounds. As such, once their capacity has been exceeded, they can no longer remove such chemical compounds potentially allowing them to proceed on to the fuel cell and potentially causing significant damage.

However, embodiments herein can include fuel cell chemical filter monitoring systems that can accurately track remaining useful life of chemical filters for fuel cells allowing them to be replaced or otherwise serviced in a timely manner to prevent damage to fuels cells. In various embodiments, the fuel cell chemical filter monitoring systems can include a processing unit and a sensor package. The sensor package can include one or more sensors. The sensor package can be configured to interface with an air flow channel of a fuel cell system upstream of a chemical filter and detect an amount of a chemical compound in the air flow channel. The sensor package can be operatively connected to the processing unit. The processing unit can be configured to track total exposure of the chemical filter to the chemical compound. The processing unit can be configured to estimate a remaining life of the chemical filter based on the tracked total exposure of the chemical filter and data regarding the total capacity of the chemical filter.

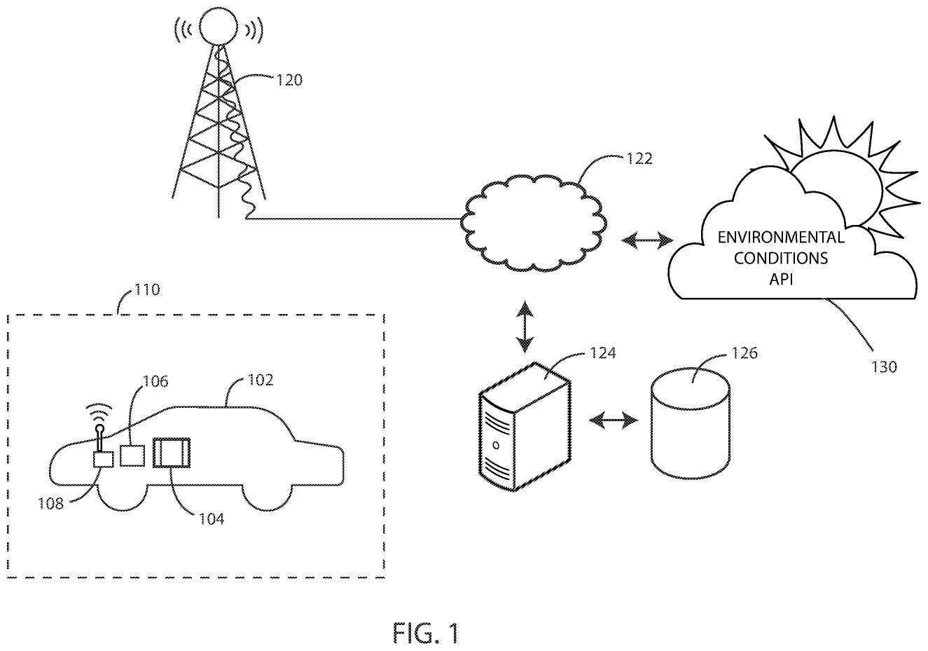

Referring now to FIG. 1, a schematic view of some components of a fuel cell chemical filter monitoring system 108 is shown in accordance with various embodiments herein. FIG. 1 shows the fuel cell chemical filter monitoring system 108 within a vehicle 102. The vehicle 102 can include a fuel cell system 104 and a chemical filter 106 that is monitored. It will be appreciated, however, that monitoring systems herein are not limited to fuel cells used with vehicles. Rather, monitoring systems herein can be used with fuel cells used in any application.

The monitoring system 108 can be in electronic communication (wired and/or wireless) with various other systems and components to send and/or receive data. In some embodiments, wireless communications to a data network can be executed with communications passing through a cell tower 120. However, in some embodiments communications can be passed using other wireless data communication network infrastructure including, for example, satellite based architecture or other data networks. In some embodiments, at least some data communications can be via wired infrastructure.

As an example, the system 108 can be in data communication with remote computing resources (servers—real or virtual, databases, and the like) such as those in or available through the cloud 122. In the example of FIG. 1, the system 108 can be in data communication with a remote system 124, such as one including a remote database 126, for purposes of sending and/or receiving data.

As shown below, the sensor package of the system 108 can be configured to interface with an air flow channel of the fuel cell system 104. In specific, the sensor package of the system 108 can be configured to interface with an air flow channel of the fuel cell system 104 upstream of the chemical filter 106. The sensor package of the system 108 and can detect and record amounts of various chemical compounds in the air flow channel. In this manner, the system 108 can track the total amounts of chemicals that the filter 106 is exposed to. By subtracting such amounts from the known total capacity of the chemical filter 106 to absorb or otherwise sequester such chemical compounds or the known remaining capacity of the filter, the remaining useful life of the chemical filter 106 can be estimated.

In one approach, the total starting capacity of the chemical filter 106 can be a starting point in making calculations to estimate the remaining useful life of the chemical filter 106. Then, as amounts of chemicals are detected with the sensor package, the remaining capacity can be calculated as the starting capacity minus all detected amounts of chemicals observed in the aggregate since the chemical filter 106 was new or serviced. In some embodiments, the rate at which the chemical filter 106 is exposed to chemical compounds can be calculated (units per time period) and this rate can then be used along with the total remaining capacity to calculate an expected time at which the chemical filter will reach its full capacity (e.g., no remaining useful life).

It will be appreciated, however, that various techniques can be used to calculate and/or estimate a remaining useful life of the chemical filter. In various embodiments, the processing unit can be configured to estimate a remaining life of the chemical filter based on the tracked total exposure of the chemical filter and the data regarding the total capacity of the chemical filter using a linear equation, a non-linear equation, a machine-learning derived algorithm, a neural network, a deep learning model, a simulation, or a digital twin. For example, in some embodiments, a training set of data can be obtained relating detected amounts of chemical compounds of interest and the consumption of capacity of the chemical filter. The training set of data can be used to train a machine learning model and the output of the same can then be used by the system in order to calculate consumption of the capacity of the chemical filter and then calculate a remaining useful life of the chemical filter. For example, a supervised machine learning approach can be used with the training set of data to develop a machine learning model or algorithm that can be used by the system herein. Other machine learning approaches used can include unsupervised machine learning, semi-supervised machine learning, reinforcement learning, and the like. Algorithms applied can include nearest neighbor, naïve Bayes, decision trees, linear regression, support vector machines, neural networks, and the like. Other algorithms applied can include k-mean clustering, association rules, Q-learning, temporal difference, deep adversarial networks, and the like.

In some embodiments, data regarding total capacity can be specific for individual chemical species of interest (e.g., capacity for compound “A” is 5 “units”, capacity for compound “B” is 7 “units”, etc.). In some embodiments, data regarding total capacity can relate to certain classes of compounds. In some embodiments, data regarding total capacity can represent an aggregate of all chemical species that the filter element can absorb or otherwise sequester.

In various embodiments, the total capacity of total capacity of the chemical filter can be input into the fuel cell chemical filter monitoring system 108 manually by a system user (located at the site of the vehicle or remotely located). In various embodiments, the fuel cell chemical filter monitoring system 108 receives data regarding the total capacity of the chemical filter from a remote system 124. In some embodiments, the fuel cell chemical filter monitoring system 108 receives data regarding the total capacity of the chemical filter from the chemical filter 106 itself. For example, the chemical filter can include a data tag (such as a RFID tag or NFC tab) bearing data thereon including, for example, the model of the chemical filter and/or the capacity of the chemical filter. In some embodiments, the total capacity of a chemical filter along with data reflecting the quantity of chemicals it has already been exposed to can be stored within memory of the fuel cell chemical filter monitoring system 108. In some embodiments, the total capacity of the chemical filter can be estimated based on filter parameters such as filter geometry, absorbent materials used and their properties, sizing, and the like.

In various embodiments, the fuel cell chemical filter monitoring system 108 can be configured to issue an alert when the remaining useful life of the chemical filter 106 crosses a threshold value. For example, the fuel cell chemical filter monitoring system 108 can be configured to issue an alert when the remaining useful life of the chemical filter 106 falls below a threshold value. The threshold value can be denominated in various ways. In some embodiments, the threshold value is a percentage of capacity of the chemical filter, such as 30%, 20%, 10%, 5%, 1%, or the like, or an amount falling within a range between any of the foregoing. In some embodiments, the threshold value is an estimated amount of time (based on current rates of chemical filter use) until the chemical filter has reached its capacity, such as 30 minutes, 1 hour, 6 hours, 12 hours, 24 hours, or the like, or an amount of time falling within a range between any of the foregoing. In some embodiments, the threshold value is an estimated amount of miles the vehicle can travel until the chemical filter has reached its capacity (based on calculated usage rates per time period and average speeds per time period), such as 10 miles, 50 miles, 100 miles, 200 miles, or the like, or a distance falling within a range between any of the foregoing. In various embodiments, the fuel cell chemical filter monitoring system 108 can be configured to issue alerts according to a tiered severity scheme when the remaining life the chemical filter 106 crosses one or more threshold values. For example, a first alert can be issued when the remaining capacity of the chemical filter falls below 10% of its total capacity and a second alert, at a higher severity level than the first alert, can be issued when the remaining capacity of the chemical filter falls below 2% of its total capacity. Many different tiered alerting schemes are contemplated herein.

In various embodiments, the fuel cell chemical filter monitoring system 108 can be configured to send data on to other systems (co-located with the vehicle and/or located remotely), such as data regarding at least one of tracked total exposure, estimated remaining filter life, alerts, etc. For example, in various embodiments, the fuel cell chemical filter monitoring system 108 can send data to a vehicle control or data system. As another example, the fuel cell chemical filter monitoring system 108 can send data to a vehicle CANbus system. In various embodiments, the fuel cell chemical filter monitoring system can send data to a remote monitoring system. Similarly, in some embodiments, the fuel cell chemical filter monitoring system 108 can receive data from such sources.

In FIG. 1, the vehicle 102 is shown at a vehicle geolocation 110. Using various techniques and/or hardware, the system 108 can determine the vehicle geolocation 110, which can be used in various ways. Geolocation data can include latitude/longitude coordinates and/or other location identifying information such as a nearest address, nearest landmark, etc. As used herein, the term “geolocation data” shall include reference to all location identifying data, unless the context dictates otherwise. In some cases, geolocation data can be derived from a satellite-based geolocation system. Such systems can include, but are not limited to, GPS L1/L2, GLONASS G1/G2, BeiDou B1/B2, Galileo E1/E5b, SBAS, or the like. In various embodiments, the system can include a geolocation circuit that can include appropriate signal receivers or transceivers to interface with a satellite and/or the geolocation circuit can interface with and/or receive data from a separate device or system that provides geolocation data or derives geolocation data from a satellite or other device. However, it will be appreciated that geolocation data herein is not limited to just that which can be received from or derived from interface with a satellite. Rather, geolocation data can also be derived from addresses, beacons, landmarks, various referential techniques, IP address evaluation, and the like.

Geolocation data can be used by the system in various ways. As one example, the vehicle geolocation 110 can be used to retrieve data regarding environmental levels of a chemical compound at the geolocation 110 of the vehicle 102 from a remote system 124. For example, in some embodiments, the system 108 can be in data communication (such as through the cloud 122 or another data network) with an API serving as a source of data, such as an environmental conditions API 130. The environmental conditions API 130 can provide data on ambient levels of various chemical compounds at specific geolocation such as concentrations of one or more of SO₂, H₂S, NO₂, NH₃, and various volatile organic compounds. Thus, in various embodiments the fuel cell chemical filter monitoring system can be configured to receive data regarding environmental levels of the chemical compound from a remote system using geolocation data from the geolocation circuit.

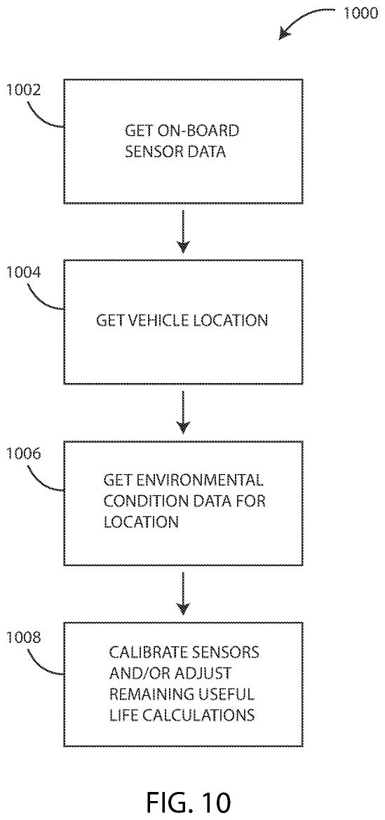

Such data regarding environmental conditions at the geolocation of the vehicle (or at the location of the fuel cell) can be used in various ways. In various embodiments, the fuel cell chemical filter monitoring system 108 can be configured to use the received data to calibrate one or more sensors. Aspects of this are described with respect to FIG. 10 below. In various embodiments, the fuel cell chemical filter monitoring system 108 can be configured to use the received data to modulate estimate calculations regarding remaining life of the chemical filter 106. Aspects of this are described with respect to FIG. 10 below.

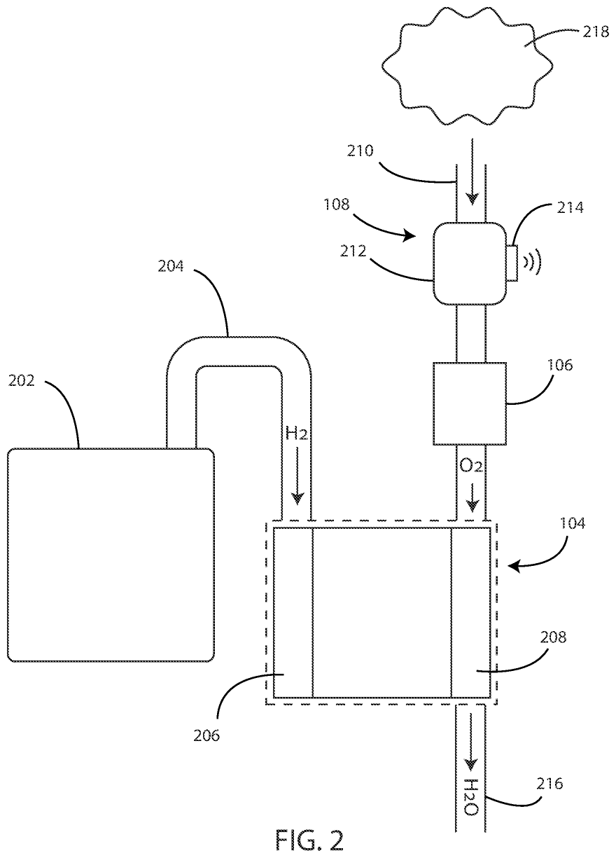

Referring now to FIG. 2, a schematic view of components of a fuel cell chemical filter monitoring system 108 is shown in accordance with various embodiments herein. The fuel cell system 104 includes a hydrogen supply tank 202 in fluid communication with a hydrogen supply line 204 that conveys the hydrogen to the fuel cell. The fuel cell system 104 can include an anode 206 and a cathode 208. The fuel cell system 104 also includes an air supply line 210. Typically, ambient gases 218 are pulled into the air supply line 210. The air provided by the air supply line 210 can be the source of the oxygen needed for the fuel cell to operate.

The fuel cell chemical filter monitoring system 108 can interface with (and be in fluid communication with) the air supply line 210 upstream from the chemical filter 106. The fuel cell chemical filter monitoring system 108 includes a sensor package 212. The sensor package 212 includes various chemical sensors as described herein. The fuel cell chemical filter monitoring system 108 can also includes a processing unit 214. In some embodiments, the sensor package 212 and the processing unit 214 can be physically integrated. In other embodiments, they can be physical separate but in wired or wireless communication with one another. FIG. 2 also shows a chemical filter 106. Exemplary chemical filters 106 are described in U.S. Pat. No. 7,138,008, the content of which is herein incorporated by reference. The fuel cell system 104 also includes a waste stream output 216, such as to convey water and other byproducts out of the fuel cell.

As referenced above, in various embodiments the sensor package 212 can be configured to interface with the air flow channel or air supply line 210 of a fuel cell system 104 upstream of the chemical filter 106. In various embodiments, the sensor package 212 can be configured to detect an amount of a chemical compound in the air supply line 210. In various embodiments, the chemical compound can include at least one including at least one of an acid species, a base species, and a volatile organic compound. In various embodiments, the chemical compound can include at least one including at least one of SO₂, H₂S, NO₂, NH₃, and a volatile organic compound.

Correspondingly, in various embodiments, the sensor package 212 can include at least one sensor selected from the group consisting of a sensor for an acid species, a sensor for a base species, and a sensor for a volatile organic compound. In various embodiments, the sensor package 212 can include at least one sensor selected from the group consisting of a SO₂ sensor, a H₂S sensor, a NO₂ a sensor, a NH₃ sensor, and a volatile organic compound sensor. In various embodiments, the sensor package 212 can be operatively connected to the processing unit 214. Other sensors can also be included herein. In various embodiments, the sensor package 212 can also include at least one selected from the group consisting of a temperature sensor, a relative humidity sensor, and a pressure sensor. In some embodiments, the sensor package 212 can also include a flow sensor.

In various embodiments, the processing unit 214 can be configured to receive an input regarding a filter change event. In various embodiments, the input can be a user input. In various embodiments, the input can be received from another sensor or system, such as a sensor attached to the chemical filter configured to detect removal of the same. When a filter change event notification is received or a filter change event is otherwise detected, the system can determine the capacity of the new filter (through user input, reference to a database, as preprogrammed, or as received from the new filter itself) and then reset the stored remaining capacity data to reflect the total capacity of the new filter element.

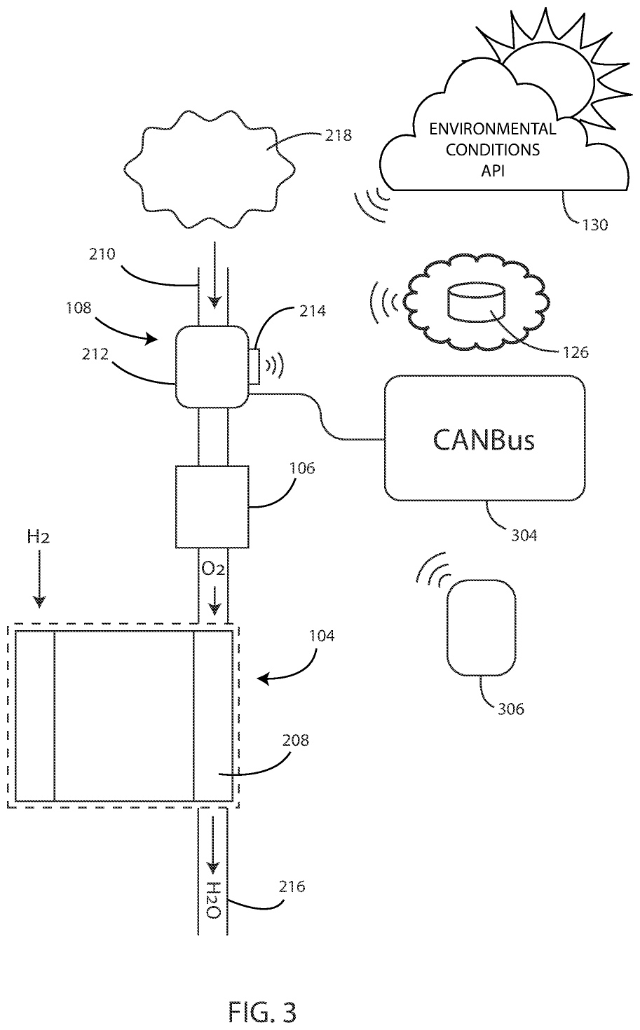

It will be appreciated that the fuel cell chemical filter monitoring system 108 can receive data from and/or send data to many different other devices and systems. Referring now to FIG. 3, a schematic view of components of a fuel cell chemical filter monitoring system 108 is shown in accordance with various embodiments herein. FIG. 3 is generally similar to FIG. 2. However, FIG. 3 also shows an ambient conditions sensor 306 (such as may be mounted on or in the vehicle), a vehicle CANBus system 304 or other vehicle control system or data network, an environmental conditions API 130, and a remote database 126. In various embodiments, the ambient conditions sensor 306 can be mounted on or in the vehicle and can detect ambient conditions including, but not limited to, concentrations of at least one of SO₂, H₂S, NO₂, NH₃, and various volatile organic compounds, and/or temperature, pressure, relative humidity, and the like.

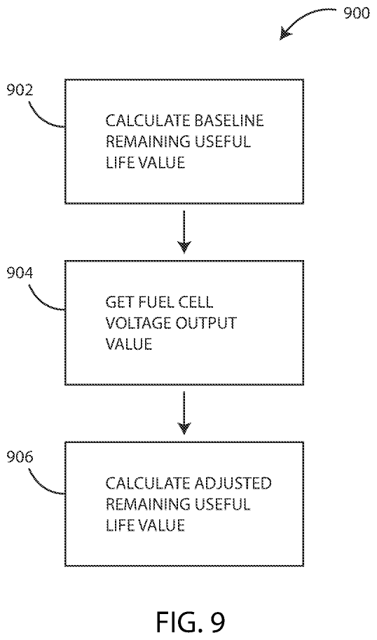

In some embodiments, the vehicle CANBus system 304 (or a similar data network) can provide information on the fuel cell, such as the power output of the fuel cell. As such, in various embodiments, the system 108 and/or the processing unit 214 thereof can be configured to receive data regarding power output (such as voltage) from the fuel cell. In various embodiments, the processing unit 214 can be configured to use the data regarding power output to modulate estimate calculations regarding remaining life of the chemical filter 106. For example, if the power output is observed to drop, this may indicate problems with the fuel cell (or a subunit cell thereof). For example, this could mean that some chemical compounds have passed into the fuel cell causing damage thereto. In such a case, the system can make further calculations regarding remaining useful capacity on a more conservative basis. This is further described with respect to FIG. 9 below.

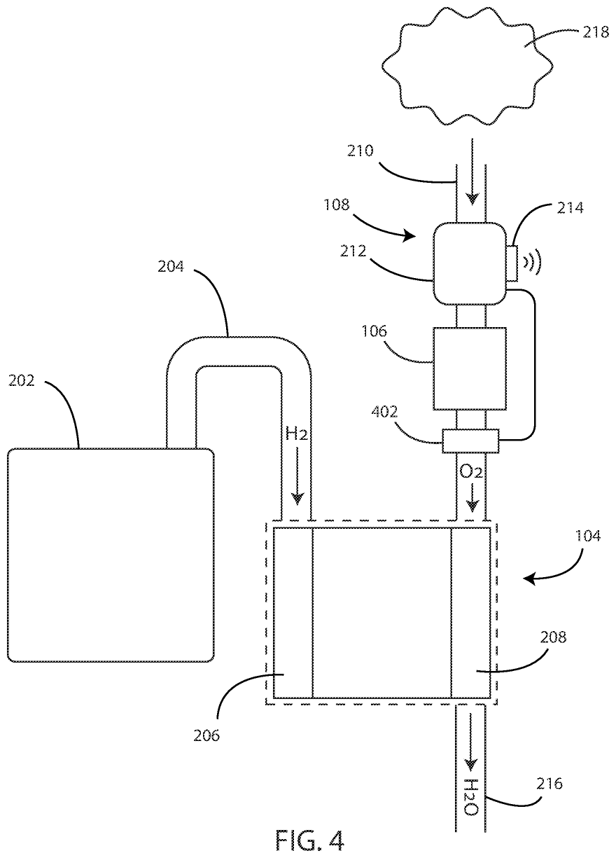

While in many embodiments herein sensing for various chemical species is performed upstream from the chemical filter, in some embodiments some sensing can also be performed downstream from the chemical filter. Referring now to FIG. 4, a schematic view of components of a fuel cell chemical filter monitoring system 108 is shown in accordance with various embodiments herein. FIG. 4 is generally similar to FIG. 2. However, FIG. 4 also shows a downstream sensor 402. The downstream sensor 402 can be used for sensing various chemical compounds referred to herein. However, in some embodiments, the downstream sensor 402 can specifically be used to detect one or more VOCs.

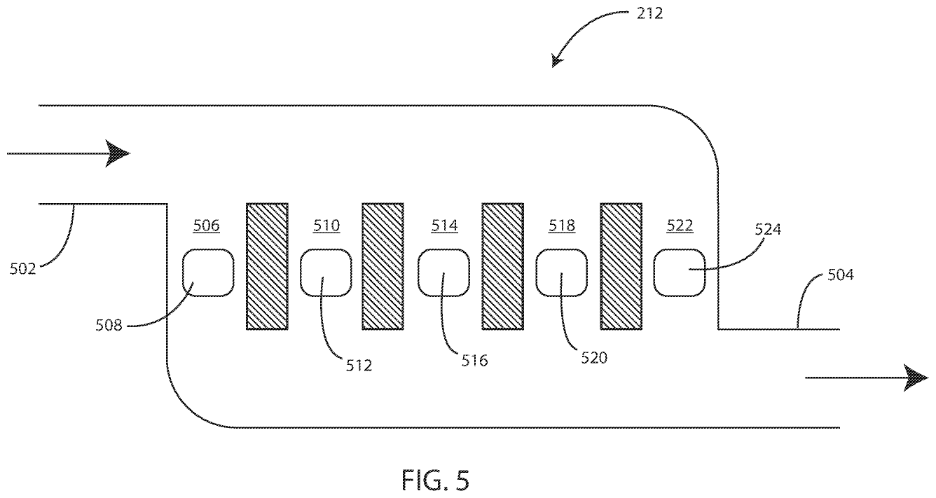

Sensor packages used herein can take on many different configurations and form factors. In some embodiments, the flow of air can be separated into multiple parallel channels. Referring now to FIG. 5, a schematic view of a portion of a sensor package 212 is shown in accordance with various embodiments herein. The sensor package 212 includes an inflow channel 502 and an outflow channel 504. The air flow can be divided up into multiple parallel flow paths. In FIG. 5, the air flow can be divided into a first path 506, a second path 510, a third path 514, a fourth path 518, and a fifth path 522. Sensors can be disposed within the flow paths. For example, a first sensor 508 can be disposed within first path 506. A second sensor 512 can be disposed within second path 510. A third sensor 516 can be disposed within third path 514. A fourth sensor 520 can be disposed within fourth path 518. A fifth sensor 524 can be disposed within fifth path 522.

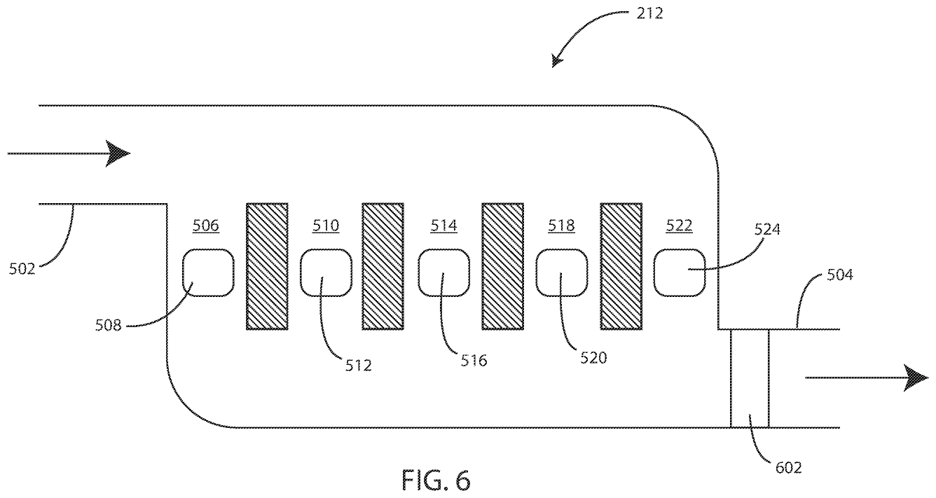

Referring now to FIG. 6, a schematic view of a portion of a sensor package 212 is shown in accordance with various embodiments herein. FIG. 6 is generally similar to FIG. 5. However, in FIG. 6 a flow sensor 602 is also included. In this example, flow sensor 602 is located in outflow channel 504. However, flow sensor 602 could also be located in housing 502, or one or more of the parallel flow paths.

In various embodiments, the sensors can include at least one including at least one of an SO₂ sensor, an H₂S sensor, an NO₂ sensor, an NH₃ sensor, and a volatile organic compound (VOC) sensor. However, in some embodiments, sensors can include an acid sensor, a base sensor, and a VOC sensor.

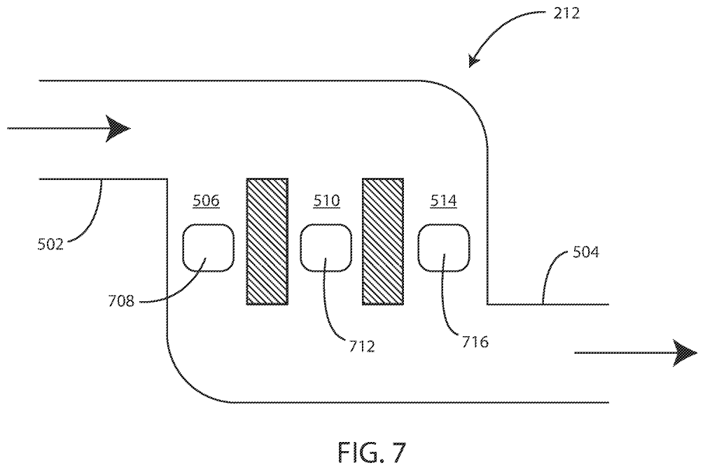

Referring now to FIG. 7, a schematic view of a portion of a sensor package 212 is shown in accordance with various embodiments herein. FIG. 7 is generally similar to FIG. 5. However, in FIG. 7 the parallel flow paths includes a first path 506, a second path 510, and a third path 514. In cases herein, sensors can detect classes of compounds instead of individual chemical compounds. For example, in some embodiments herein, sensors can detect acids, bases, and the like. As such, in this example the sensors can include an acid sensor 708 disposed within the first path 506, a base sensor 712 disposed within the second path 510, and a VOC sensor 716 disposed within the third path 514.

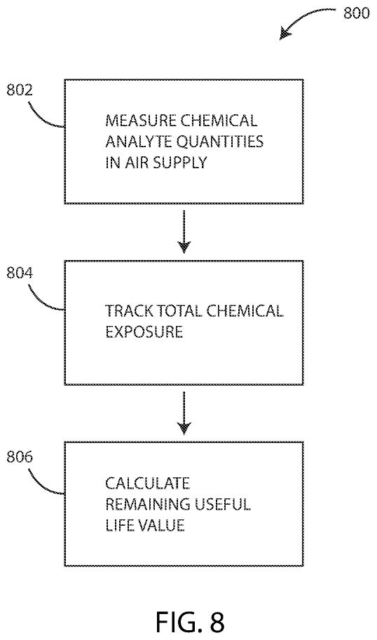

Referring now to FIG. 8, a flowchart of operations is shown in accordance with various embodiments herein. In specific, FIG. 8 shows a method of monitoring a fuel cell chemical filter 800. The method of monitoring a fuel cell chemical filter 800 can include an operation of detecting an amount of a chemical compound in an air flow channel 802. The method of monitoring a fuel cell chemical filter 800 can also include an operation of a tracking total exposure of a chemical filter to a chemical compound 804. The method of monitoring a fuel cell chemical filter 800 can also include an operation of estimating a remaining life of a chemical filter based on the tracked total exposure of the chemical filter and data regarding the total capacity of the chemical filter 806.

Referring now to FIG. 9, a flowchart of operations is shown in accordance with various embodiments herein. The method 900 can include an operation of calculating a baseline value for remaining useful filter file (RUL) 902. In some embodiments, the method can further include an operation of getting fuel cell voltage output values 904. In some embodiments, the method can further include an operation of calculating an adjusted value for remaining useful filter life 906 in view of the fuel cell voltage output values. As an example, if the power output from the fuel cell is observed to drop, this may indicate problems with the fuel cell (or a subunit cell thereof). This could mean that some chemical compounds have passed into the fuel cell causing damage thereto and/or reduced power out therefrom. In such a case, the system can make further calculations regarding remaining useful capacity on a more conservative basis. For example, the calculated remaining useful life that was present at the time that fuel cell power output dropped can be used as the new point where zero remaining useful life is estimated. So, for example, if the baseline calculation for remaining useful life indicates that the remaining useful life is 20% of the total starting capacity, but fuel cell power output drops at that point, then further calculations of remaining useful life can be scaled accordingly such as by multiplying values for remaining useful life by a correction factor.

Referring now to FIG. 10, a flowchart of operations is shown in accordance with various embodiments herein. The method 1000 can include an operation of getting on-board sensor data 1002, such as from a sensor package. The method 1000 can further include an operation of getting vehicle geolocation 1004. The method 1000 can further include an operation of getting environmental condition data for the given geolocation 1006. The method 1000 can further include an operation of calibrating sensors and/or adjusting remaining useful life calculations 1008. For example, in some embodiments, the environmental condition data can be taken as being accurate and data from the sensors in the sensor package can be adjusted using a correction factor such that they accurately reflect concentrations of chemical species as indicated by the environmental condition data. In some embodiments, remaining useful life calculations can be adjusted using the environmental condition data. For example, if the environmental condition data indicated high levels of various chemical species of interest, then the system can adjust the remaining useful life calculations to be more conservative (e.g., to reflect that the remaining useful life has been used up more quickly).

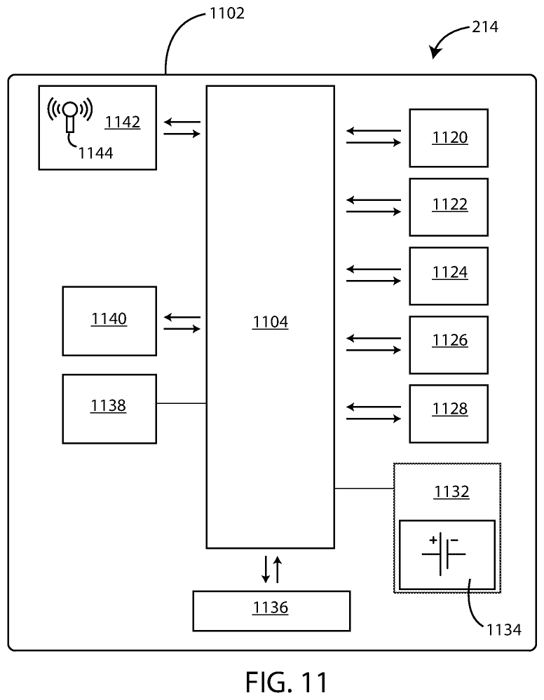

Various components can be used with systems herein. Referring now to FIG. 11, a block diagram view of components of a processing unit 214 is shown in accordance with various embodiments herein. It will be appreciated, however, that a greater or lesser number of components can be included with various embodiments and that this schematic diagram is merely illustrative. The processing unit 214 can include a housing 1102 and a control circuit 1104.

The control circuit 1104 can include various electronic components including, but not limited to, a microprocessor, a microcontroller, a FPGA (field programmable gate array) chip, an application specific integrated circuit (ASIC), or the like.

In various embodiments, the processing unit 214 can include a first sensor channel 1120, a second sensor channel 1122, a third sensor channel 1124, a fourth sensor channel 1126, and a fifth sensor channel 1128. The sensor channels can provide an interface with the sensors used and, in various embodiments, execute various operations on the data/signals from the sensors including amplification, noised reduction, sampling frequency adjustments, and the like. However, it will be appreciated that greater or lesser numbers of sensor channels can be used herein.

The processing power of the control circuit 1104 and components thereof can be sufficient to perform various operations including various operations on data from sensors including, but not limited to averaging, time-averaging, statistical analysis, normalizing, aggregating, sorting, deleting, traversing, transforming, condensing (such as eliminating selected data and/or converting the data to a less granular form), compressing (such as using a compression algorithm), merging, inserting, time-stamping, filtering, discarding outliers, calculating trends and trendlines (linear, logarithmic, polynomial, power, exponential, moving average, etc.), predicting filter RUL (remaining useful life), identifying an RUL condition, predicting performance, predicting costs associated with replacing filter elements vs. not-replacing filter elements, and the like.

Normalizing operations performed by the control circuit 1104 can include, but are not limited to, adjusting one or more values based on another value or set of values. As just one example, on-board sensor data (e.g., data from sensors of the sensor package) can normalized based on environmental condition data.

In various embodiments the control circuit can calculate a time for replacement of a filter/filter element and generate a signal regarding the time for replacement. In various embodiments, the control circuit can calculate a time for replacement of a filter element and issue a notification regarding the time for replacement through a user output device. In various embodiments, the control circuit can calculate a time for replacement of a filter element based on signals from the sensors herein as well as data regarding the capacity of the filter/filter element.

In various embodiments, the control circuit initiates an alert or alarm if a predetermined alarm condition has been met. The alarm condition can include one or more a maximum value for a signal received from a chemical sensor herein, crossing a threshold value for remaining useful life of a chemical filter herein, or the like.

In various embodiments, the processing unit 214 can include a power supply circuit 1132. In some embodiments, the power supply circuit 1132 can include various components including, but not limited to, a battery 1134, a capacitor, a power-receiver such as a wireless power receiver, a transformer, a rectifier, and the like. In various embodiments, instead of and/or in addition to receiving power from a battery, the power supply circuit 1132 can receive power from a power supply on the vehicle itself such as a DC power source associated with the vehicle (or even an AC power source in some scenarios).

In various embodiments the processing unit 214 can include an output device 1136. The output device 1136 can include various components for visual and/or audio output including, but not limited to, lights (such as LED lights), a display screen, a speaker, and the like. In some embodiments, the output device can be used to provide notifications or alerts to a system user such as current system status, an indication of a problem, a required user intervention, a proper time to perform a maintenance action, or the like.

In various embodiments the processing unit 214 can include memory 1138 and/or a memory controller. The memory can include various types of memory components including dynamic RAM (D-RAM), read only memory (ROM), static RAM (S-RAM), disk storage, flash memory, EEPROM, battery-backed RAM such as S-RAM or D-RAM and any other type of digital data storage component. In some embodiments, the electronic circuit or electronic component includes volatile memory. In some embodiments, the electronic circuit or electronic component includes non-volatile memory. In some embodiments, the electronic circuit or electronic component can include transistors interconnected to provide positive feedback operating as latches or flip flops, providing for circuits that have two or more metastable states, and remain in one of these states until changed by an external input. Data storage can be based on such flip-flop containing circuits. Data storage can also be based on the storage of charge in a capacitor or on other principles. In some embodiments, the non-volatile memory 1138 can be integrated with the control circuit 1104.

In various embodiments the processing unit 214 can include a clock circuit 1140. In some embodiments, the clock circuit 1140 can be integrated with the control circuit 1104. While not shown in FIG. 11, it will be appreciated that various embodiments herein can include a data/communication bus to provide for the transportation of data between components. In some embodiments, an analog signal interface can be included. In some embodiments, a digital signal interface can be included.

In various embodiment the processing unit 214 can include a communications circuit 1142. In various embodiments, the communications circuit can include components such as an antenna 1144, amplifiers, filters, digital to analog and/or analog to digital converters, and the like. The communications circuit 1142 can facilitate wired and/or wireless communications to and from the system.

### Methods

Many different methods are contemplated herein, including, but not limited to, methods of making, methods of using, and the like. Aspects of system/device operation described elsewhere herein can be performed as operations of one or more methods in accordance with various embodiments herein.

In various embodiments, operations described herein and method steps can be performed as part of a computer-implemented method executed by one or more processors of one or more computing devices. In various embodiments, operations described herein and method steps can be implemented instructions stored on a non-transitory, computer-readable medium that, when executed by one or more processors, cause a system to execute the operations and/or steps.

In an embodiment, a method of monitoring a fuel cell chemical filter is included. The method can include interfacing with an air flow channel of a fuel cell system upstream of a chemical filter. The method can also include detecting an amount of a chemical compound in the air flow channel. The method can also include tracking total exposure of the chemical filter to the chemical compound. The method can also include estimating a remaining life of the chemical filter based on the tracked total exposure of the chemical filter and data regarding the total capacity of the chemical filter.

In an embodiment, the method can further include sending data regarding at least one of tracked total exposure and estimated remaining filter life.

In an embodiment, the method can further include receiving data regarding environmental levels of the chemical compound from a remote system. In an embodiment, the method can further include sending geolocation data to the remote system in order to get data regarding environmental levels of the chemical compound that is specific for the geolocation of the vehicle or other system. In an embodiment of the method, receiving data regarding environmental levels of the chemical compound from a remote system can include using the received data to modulate estimate calculations regarding remaining life of the chemical filter. In an embodiment of the method, receiving data regarding environmental levels of the chemical compound from a remote system can include using the received data to calibrate one or more sensors.

In an embodiment, the method can further include receiving an input regarding a filter change event.

In an embodiment, the method can further include receiving data from a vehicular data system. In an embodiment, the method can further include receiving data regarding power output from the fuel cell. In an embodiment of the method, receiving the data regarding power output from the fuel cell can include using the data regarding power output to modulate estimate calculations regarding remaining life of the chemical filter.

In an embodiment, the method can further include issuing an alert when the remaining life the chemical filter crosses a threshold value. In an embodiment, the method can further include issuing alerts according to a tiered severity scheme when the remaining life the chemical filter crosses one or more threshold values.

### Sensor Package

Various embodiments herein include one or more sensors. Further details about the sensors are provided as follows. However, it will be appreciated that this is merely provided by way of example and that further variations are contemplated herein.

Sensors herein can include, but are not limited to, an SO₂ sensor, an H₂S sensor, an NO₂ sensor, an NH3 sensor, and a volatile organic compound (VOC) sensor. In some embodiments, sensors herein can be specific for a particular compound. In other embodiments, sensors herein can be specific for a class or group of compounds. In the later case, estimates of the concentration of the specific compound can be generated by multiplying by a correction factor which takes into account the amount of the signal that is related to the specific compound in question. For example, if the sensor signal reflects contributions from all bases, then a contribution factor can be used to estimate the amount of NH₃ reflected in the overall signal. For example, the concentration of NH₃ can be calculated as NH₃=base sensor signal*k_base, wherein k_base is the contribution or correction factor and reflects the ratio of NH₃ to all bases in the air sample. The correction factor can be derived through a calibration procedure. Concentration values can be converted to total exposure amounts by adjusting for the flow rate and the sampling time. Total exposure amounts can be tracked and subtracted from filter total capacity values to get remaining capacity.

Sensors herein can operate according to many different principles of operation. Sensors herein can include, but are not limited to, electrochemical sensors. In some embodiments, electrochemical sensors can operate by contacting and/or reacting with a gas sample and producing an electrical signal proportional to the gas concentration of a specific chemical species or the concentration of a specific class of gases within the gas sample. In some embodiments, chemical sensors herein can be optical chemical sensors. Other sensor types herein can include, but are not limited to, liquid film ion sensors, ion selective FETs, solid film ion sensors, semiconductor gas sensors, contact combustion gas sensors, polymer gas sensors, capacitance-based sensors, resistance-based sensors, and the like. Exemplary sensors herein can include, but are not limited to, the ALPHASENSE H2S-B4, ALPHASENSE S02-B4, ALPHASENSE N02-B43F, SGX SENSORTECH MiCS-5914, BOSCH BME688, and the like.

The sensitivity of sensors herein can vary. In some embodiments, sensitivities can be 1000 ppm, 500 ppm, 100 ppm, 10 ppm, 5 ppm, 1 ppm, 100 ppb, 50 ppb, 25 ppb, 10 ppb, or even 5 ppb, or a sensitivity falling within a range between any of the foregoing. While not intending to be bound by theory, configurations herein where the sensor package is configured to interface with and airflow channel upstream from the chemical filter are advantageous because sensors with lesser sensitivity values can be used. In specific, upstream of the chemical filter, the concentrations of chemical species of interest herein are relatively high compared with what they may be downstream of the chemical filter. Thus, sensors can be used herein with relatively lesser sensitivity.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A fuel cell chemical filter monitoring system comprising:
a processing unit; and
a sensor package, the sensor package comprising one or more sensors;
wherein the sensor package is configured to
interface with an air flow channel of a fuel cell system upstream of a chemical filter; and
detect an amount of a chemical compound in the air flow channel;
wherein the sensor package is operatively connected to the processing unit;
wherein the processing unit is configured to track total exposure of the chemical filter to the chemical compound; and
wherein the processing unit is configured to estimate a remaining life of the chemical filter based on the tracked total exposure of the chemical filter and data regarding the total capacity of the chemical filter.

2. The fuel cell chemical filter monitoring system of claim 1, the chemical compound comprising at least one selected from the group consisting of an acid species, a base species, and a volatile organic compound.

3. The fuel cell chemical filter monitoring system of claim 1, the chemical compound comprising at least one selected from the group consisting of SO₂, H₂S, NO₂, NH₃, and a volatile organic compound.

4. The fuel cell chemical filter monitoring system of claim 1, the one or more sensors comprising at least one selected from the group consisting of an acid sensor, a base sensor, and a volatile organic compound (VOC) sensor.

5-7. (canceled)

8. The fuel cell chemical filter monitoring system of claim 1, wherein the fuel cell chemical filter monitoring system is configured to send data regarding at least one of tracked total exposure and estimated remaining filter life.

9-11. (canceled)

12. The fuel cell chemical filter monitoring system of claim 1, the sensor package further comprising at least one selected from the group consisting of a temperature sensor, a relative humidity sensor, and a pressure sensor.

13. The fuel cell chemical filter monitoring system of claim 1, the sensor package further comprising a flow sensor.

14. The fuel cell chemical filter monitoring system of claim 1, further comprising a geolocation circuit.

15. The fuel cell chemical filter monitoring system of claim 14, wherein the fuel cell chemical filter monitoring system is configured to receive data regarding environmental levels of the chemical compound from a remote system using geolocation data from the geolocation circuit.

16. The fuel cell chemical filter monitoring system of claim 1, wherein the fuel cell chemical filter monitoring system is configured to receive data regarding environmental levels of the chemical compound from a remote system.

17. The fuel cell chemical filter monitoring system of claim 16, wherein the fuel cell chemical filter monitoring system is configured to use the received data to calibrate the one or more sensors.

18. The fuel cell chemical filter monitoring system of claim 16, wherein the fuel cell chemical filter monitoring system is configured to use the received data to modulate estimate calculations regarding remaining life of the chemical filter.

19. The fuel cell chemical filter monitoring system of claim 1, wherein the processing unit is configured to receive an input regarding a filter change event.

20-21. (canceled)

22. The fuel cell chemical filter monitoring system of claim 1, wherein the processing unit is configured to receive data from a vehicular data system.

23. The fuel cell chemical filter monitoring system of claim 22, wherein the processing unit is configured to receive data regarding power output from the fuel cell.

24. The fuel cell chemical filter monitoring system of claim 23, wherein the processing unit is configured to use the data regarding power output to modulate estimate calculations regarding remaining life of the chemical filter.

25. (canceled)

26. The fuel cell chemical filter monitoring system of claim 1, the sensor package further comprising parallel flow paths, wherein individual sensors are disposed within individual parallel flow paths.

27. The fuel cell chemical filter monitoring system of claim 1, wherein the fuel cell chemical filter monitoring system is configured to issue an alert when the remaining life the chemical filter crosses a threshold value.

28. The fuel cell chemical filter monitoring system of claim 1, wherein the fuel cell chemical filter monitoring system is configured to issue alerts according to a tiered severity scheme when the remaining life the chemical filter crosses one or more threshold values.

29. (canceled)

30. A method of monitoring a fuel cell chemical filter comprising:
interfacing with an air flow channel of a fuel cell system upstream of a chemical filter;
detecting an amount of a chemical compound in the air flow channel;
tracking total exposure of the chemical filter to the chemical compound; and
estimating a remaining life of the chemical filter based on the tracked total exposure of the chemical filter and data regarding the total capacity of the chemical filter.

31-41. (canceled)
